(19) United States
(12) Patent Application Publication
(10) Pub. No.: US 2025/0178067 A1
(43) Pub. Date: Jun. 5, 2025

(54) METHOD OF FORMING VEHICLE PARTS USING LASER WELDED BLANKS

(71) Applicant: MAGNA INTERNATIONAL INC., Aurora (CA)

(72) Inventors: Chris GLAMCEVSKI, Keswick (CA); Alen PUSKAR, Orangeville (CA); Jason LI, Guelph (CA)

(21) Appl. No.: 18/875,857

(22) PCT Filed: Jun. 21, 2023
(86) PCT No.: PCT/CA2023/050863

§ 371 Date: Dec. 17, 2024

Related U.S. Application Data
(60) Provisional application No. 63/354,429, filed on Jun. 22, 2022.

(51) Int. Cl. B21D 53/88; B21D 22/02; B21D 28/06; B21D 35/00; B23K 26/32; B23K 101/00; B23K 101/18; B23K 103/10

(52) U.S. Cl. CPC B21D 53/88; B21D 22/02; B21D 28/06; B21D 35/006; B23K 26/32; B23K 2101/006; B23K 2101/185; B23K 2103/10

(57) ABSTRACT

A method of simultaneously forming a plurality of vehicle parts includes placing a common welded blank having a first portion joined to a second portion via a weld into a die set, and then simultaneously forming a first part in the first portion of the common welded blank and a second part in the second portion of the common welded blank. The first portion of the common welded blank can have a first thickness being different than a second thickness of said second portion and/or comprised of a first material grade being different than a second material grade of the second portion to simultaneously form the first and second parts with different thicknesses and/or different material grades. In an arrangement, each of the first and second portions can be shaped to be approximate halves of the overall common welded blank for simultaneously forming complementary parts.

### CROSS-REFERENCE TO RELATED APPLICATIONS

This PCT International Patent Application claims the benefit of and priority to U.S. Provisional Patent Application Ser. No. 63/354,429, filed Jun. 22, 2022, titled “Method Of Forming Vehicle Parts Using Welded Blanks,” the entire disclosure of which is hereby incorporated by reference.

### BACKGROUND OF THE INVENTION

### 1. Field of the Invention

The present invention relates to a method of forming vehicle parts. More particularly, the present invention relates to a method of running dies double out to simultaneously form vehicle parts.

### 2. Related Art

This section provides background information related to the present disclosure which is not necessarily prior art.

As illustrated in FIG. 1, a method of forming vehicle parts is traditionally accomplished by placing a single blank in a die to form a respective, single vehicle part, or alternatively placing two, separate unattached blanks in the die to run the parts double out. For example, FIG. 1 illustrates an upper hood part formed from a first single blank in a first stamping process and a lower hood part formed from a second, separate single blank in a second stamping process. When parts are run using these single and separate blanks, a spread is required at the front of the lien in the press which naturally widens the die set. Additionally, when parts are run using separate blanks, a specific amount of material is required outside the glass line of each part. This area is referred to as the addendum and binder surface which has beads to control the material flow. As a result, the single out and separate manufacturing process necessarily requires this material to be present in the single blank, which ultimately generates waste and adds material cost to the overall stamping process. Throughput of the stamping process is also limited to the number of die presses within a stamping plant, because each die press can only produce one part at a time, such as illustrated by FIG. 1.

Accordingly, there is a continuing desire to further develop and refine methods of forming parts that reduces material requirements for the blanks and increases throughput of the stamping process.

### SUMMARY OF THE INVENTION

According to an aspect of the disclosure, the subject invention is generally directed to a method of simultaneously forming a pair of parts using a shared or common welded blank. The common welded blank includes a first portion joined to a second portion via a weld. The common welded blank facilitates the forming of the pair of parts via a double out process, with a first part formed in the first portion of the common welded blank and a second portion formed in the second portion of the common welded blank. As will be explained in more detail in association with the following more detailed disclosure, by joining a pair of blanks (i.e., a first portion and a second portion) with a weld, and simultaneously forming the parts via the double out process, the subject method saves material for the common welded blank and reduces an overall size of the die. Additionally, running parts double out improves throughput of the stamping process relative to the traditional prior art method illustrated in FIG. 1 which requires parts to be formed via a single out/single blank process. The common welded blank also provides flexibility to simultaneously form parts double out with different thickness and/or material grades.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and are not intended to limit the scope of the present disclosure. The inventive concepts associated with the present disclosure will be more readily understood by reference to the following description in combination with the accompanying drawings wherein:

FIG. 1 illustrates exemplary single out processes for forming vehicle parts from respective single blanks in accordance with the prior art principles:

FIG. 2A is a top view of a common welded blank illustrating a first portion joined to a second portion via a weld:

FIG. 2B is a fragmentary side view of a portion of the common welded blank in FIG. 2A illustrating the first portion having a first thickness being different than a second thickness of the second portion and comprised of a first material grade being different than and a second material grade of the second portion:

FIG. 3 is a side view of a die set illustrating the common welded blank placed between an upper cavity and a lower punch for simultaneously forming a first part in the first portion and a second part in the second portion:

FIG. 4 is a top view of the first and second parts after being formed double out in the common welded blank by the die set; and

FIG. 5 is a magnified view of a portion of FIG. 4 illustrating a small spacing D between adjacent portions of the first and second parts formed in the common welded blank.

### DETAILED DESCRIPTION OF THE ENABLING EMBODIMENTS

Example embodiments will now be described more fully with reference to the accompanying drawings. In general, the subject embodiments are directed to a method of simultaneously forming a plurality of parts using a common welded blank, as well as the common welded blank used in the double out manufacturing method. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

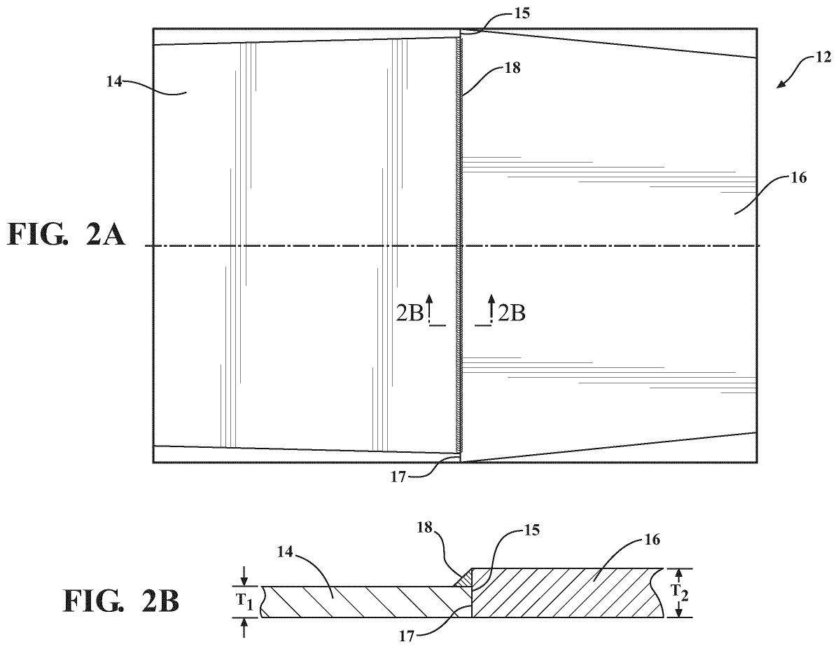

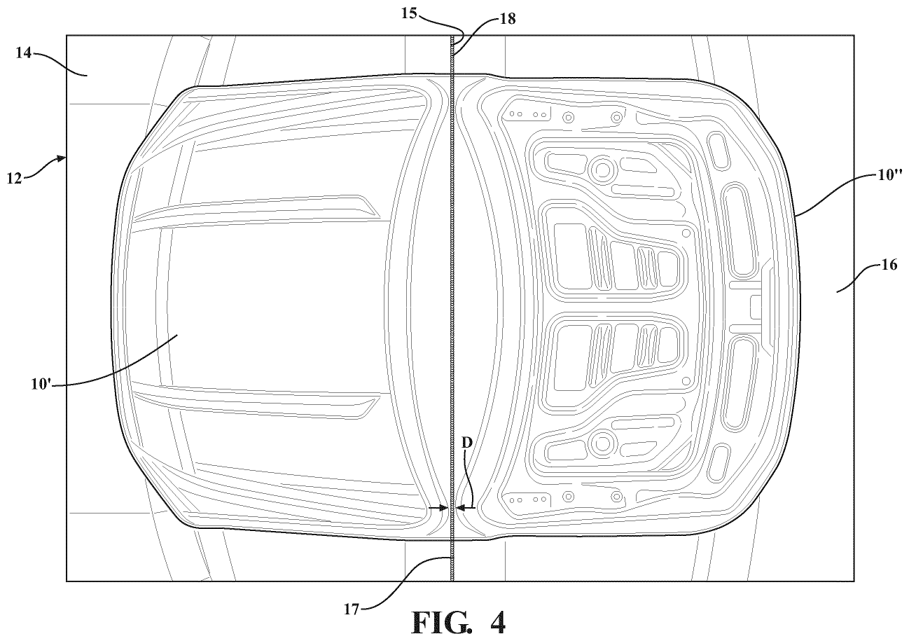

Referring to the Figures, the subject disclosure is generally directed to a method of simultaneously forming a plurality of parts 10′, 10″ using a common or shared welded blank 12. As best illustrated in FIGS. 2A, 2B and 4, the common welded blank 12 preferably includes a first portion 14 joined to a second portion 16 via a weld 18 for simultaneously forming a first part 10′ in the first portion 14 and a second part 10″ in the second portion 16. More specifically, as best illustrated in FIGS. 2A-2B, the first portion 14 includes a first shared edge 15 disposed in abutting relationship with a second shared edge 17 of the second portion 16, and the weld 18 is placed along the abutting first and second shard edges 15, 17 to form the common shared blank 12. The weld 18 is preferably formed via laser welding. However, other means of welding could be utilized without departing from the scope of the subject disclosure.

Each of the first and second portions 14, 16 are preferably comprised of aluminum, but could be comprised of different materials without departing from the scope of the subject disclosure. Additionally, although the common welded blank 12 illustrates two portions 14, 16 welded together, the common welded blank 12 could include more than two portions welded together for forming more than two parts without departing from the scope of the subject disclosure. As further illustrated in FIG. 4, the first and second portions 14, 16 are each shaped to be approximate halves of the overall laser welded blank 12 for forming complementary parts, such as an upper and lower portion of the hood (See FIG. 4). In other words, each of the first and second portions 14, 16 make-up approximately 50% of the overall size of the common welded blank 12. However, the first and second portions 14, 16 could be alternatively sized (e.g., ⅓ and ⅔ of the overall laser welded blank 12) without departing from the scope of the subject disclosure.

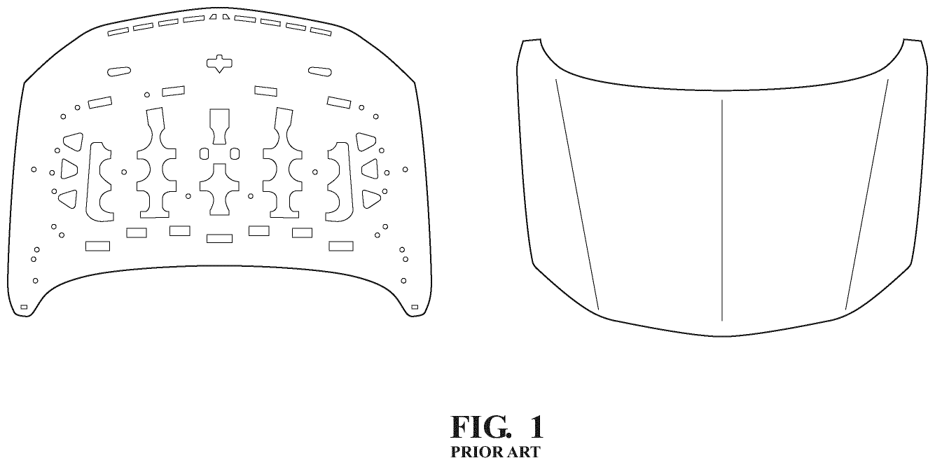

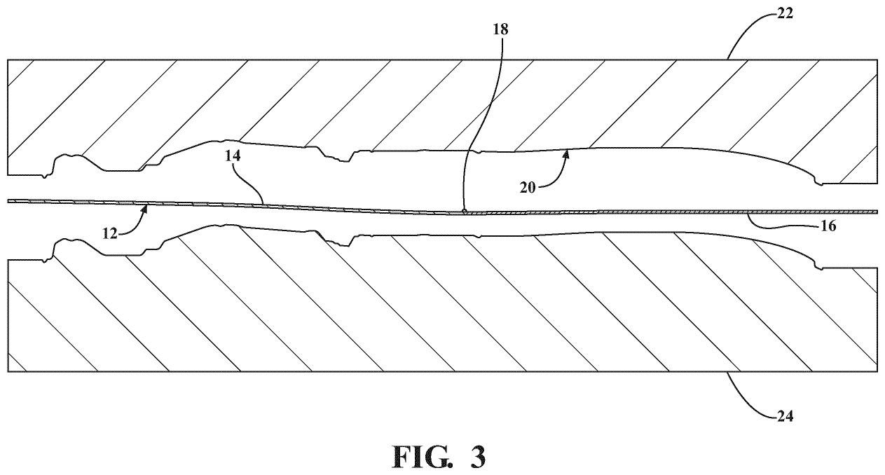

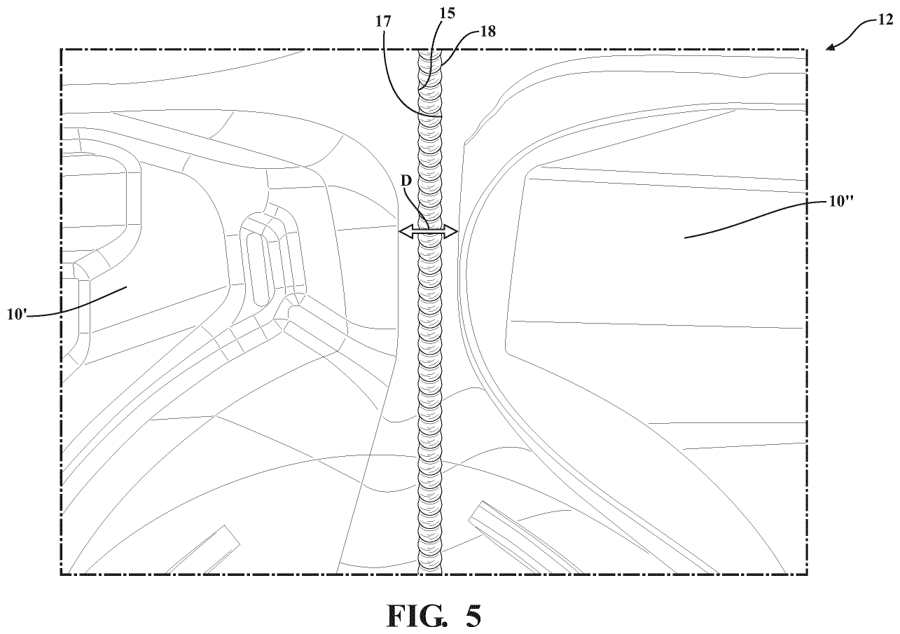

As best illustrated in FIGS. 3-4, the common welded blank 12 is placed in a die set 20, such as between an upper cavity 22 and a lower punch 24, for simultaneously forming the first part 10′ in the first portion 14 and the second part 10″ in the second portion 16. Forming the parts “double out” (i.e., at the same time on a single die set) using a common welded blank 12 provides material savings and increased throughput relative to the prior art processes which require separate single out processes or separate blanks in the double out process to form the two parts. More specifically, when running parts single out or double out with two separate and unattached blanks, an addendum and binder surface outside the glass line of each part is required in the blank to control the material flow. In contradistinction, and as best illustrated in FIG. 5, in the subject double out stamping process with the common welded blank 12, the parts can be squeezed and placed in close proximity together on the common welded blank 12, spaced apart by a small distance D, such that the addendum is shared to result in a common addendum being smaller than that of both single addendums combined (i.e., if the parts were formed in separate stamping processes). The reduced addendum size results in reduced material requirement for the laser welded blank 12 (as compared to the material requirement for the combined blanks when the two parts are formed single out via separate stamping processes, such as illustrated in FIG. 1, or double out with two separate and unattached blanks). Additionally, in a prior art double out process utilizing two separate blanks, the two blanks for the respective parts must be spread at the front of the lien in the press by a specific amount set from the press manufacturer, which naturally widens the die. However, by utilizing a common welded blank 12, this spread does not exist and allows the two parts 10′, 10″ to be nested closer together, such as by the small distance D illustrated in FIG. 5. By doing so, the ends of the dies do not need to extend out as far (since the spacing between the parts is reduced) and a resultant overall size of the die is reduced.

As best illustrated in FIG. 2B, the use of the common welded blank 12 also provides flexibility to simultaneously form parts having different thicknesses and/or comprised of different material grades. For example, in a first arrangement, the second portion 16 of the common welded blank 12 can have a second thickness T₂ being greater than a first thickness T₁ of the first portion 14 (or vice versa) such that the resultant parts formed via the double out process have different thicknesses. In a second arrangement, the first portion of the laser welded blank 12 can be comprised of a first material grade being different than a second material grade of the second portion 16 such that the resultant parts are simultaneously formed to have different material grades. In yet another arrangement, the first and second portions 14, 16 of the laser welded blank can have both different thicknesses and material grades. Thus, the subject process provides the flexibility to run dual material thickness blanks (i.e., the first and second portions 14, 16) which are welded together to ultimately form two parts of different characteristics (possibly both different thicknesses and material grades) out of the common welded blank 12.

It should be appreciated that the foregoing description of the embodiments has been provided for purposes of illustration. In other words, the subject disclosure it is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varies in many ways. Such variations are not to be regarded as a departure from the disclosure, and all such modifications are intended to be included within the scope of disclosure.

1. A method of simultaneously forming a plurality of vehicle parts comprising:
placing a common welded blank having a first portion joined to a second portion via a weld into a die set; and
simultaneously forming a first part in the first portion of the common welded blank and a second part in the second portion of the common welded blank with the die set.

2. The method as set forth in claim 1, wherein the first portion of the common welded blank having a first thickness being different than a second thickness of the second portion to simultaneous form the first part and the second part with different thicknesses.

3. The method as set forth in claim 1, wherein the first portion of the common welded blank is comprised of a first material grade being different than a second material grade of the second portion to simultaneous forming the first and second parts with different material grades.

4. The method as set forth in claim 3, wherein the first portion and the second portion are each comprised of different aluminum grades.

5. The method as set forth in claim 1, wherein the first portion of the common welded blank having a first thickness being different than a second thickness of the second portion and comprised of a first material grade being different than a second material grade of the second portion to simultaneously form the first and second parts with different thicknesses and different material grades.

6. The method as set forth in claim 1, wherein each of the first portion and the second portion are sized approximately 50% of an overall size of the common welded blank.

7. The method as set forth in claim 1, wherein the first portion having a first shared edge disposed in abutting relationship with a second shared edge of the second portion, and the weld extends along the abutting first and second shared edges to form the common welded blank.

8. The method as set forth in claim 1, wherein the weld is a laser weld.

9. A common welded blank for use with a double out stamping process, the common welded blank comprising:
a first portion joined to a second portion via a weld for simultaneously forming a first part in the first portion and a second part in the second portion.

10. The common welded blank as set forth in claim 9, wherein the first portion having a first shared edge disposed in abutting relationship with a second shared edge of the second portion, and the weld extends along the abutting first and second shared edges to form the common welded blank.

11. The common welded blank as set forth in claim 9, wherein said first portion having a first thickness being different than a second thickness of said second portion for simultaneously forming the first and second parts with different thicknesses.

12. The common welded blank as set forth in claim 9, wherein said first portion is comprised of a first material grade being different than a second material grade of said second portion for simultaneously forming the first and second parts with different material grades.

13. The common welded blank as set forth in claim 9, wherein said first portion of the common welded blank having a first thickness being different than a second thickness of said second portion and comprised of a first material grade being different than a second material grade of said second portion to simultaneously form the first and second parts with different thickness and different material grades.

14. The common welded blank as set forth in claim 9, wherein said first and second portions each comprise approximate halves of the overall common welded blank for forming complimentary parts from the common welded blank.

15. The common welded blank as set forth in claim 9, wherein said weld is a laser weld.

16. The common welded blank as set forth in claim 12, wherein the first portion and the second portion are each comprised of different aluminum grades.

17. The method as set forth in claim 1, wherein the first part and the second part are spaced from one another by a distance extending through the weld.

18. The method as set forth in claim 1, wherein the first part has a first profile being different than a second profile of the second part.

19. The method as set forth in claim 1, wherein the die set includes an upper cavity and a lower punch.
